(19) United States
(12) Patent Application Publication
(10) Pub. No.: US 2006/0093457 A1
(43) Pub. Date: May 4, 2006

(54) T nut

(76) Inventor: Tian-Fu Cao, Kaohsiung City (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 10/975,483

(22) Filed: Oct. 29, 2004

(51) Int. Cl. F16B 37/04

(52) U.S. Cl. 411/181

(57) ABSTRACT

A T nut having a tubular body with an inner thread and a flange with upright retaining teeth around one end of the tubular body is disclosed. The tubular body of the T nut has a first section connected to the flange and a second section axially extended from one end of the first section remote from the flange, which second section having a plurality of longitudinal splits that separate the periphery of the second section into multiple curve surfaces that will curve radially outwards to engage the workpiece after installation of the T nut in the workpiece and threading of a screw into the inner thread of the tubular body.

### BACKGROUND OF THE INVENTION

1. Field of the Invention

The present invention relates generally to T nuts and more particularly, to such a T nut, which is easy to install and inexpensive to manufacture.

2. Description of the Related Art

FIGS. 1 and 2 show a T nut 1 according to the prior art. According to this design, the T nut 1 comprises a tubular body 11 and a flange 12 radially extended around the periphery of the tubular body 11 at one end. The tubular body 11 has a first section 111 connected to the flange 12 and a second section 112 axially extended from one end of the first section 111 remote from the flange 12. The spaced surrounded by the first section 111 is greater than the spaced surrounded by the second section 112. The first section 111 has an inner thread 114 on the inside wall 113 thereof. The flange 12 has a plurality of upright retaining teeth 121 spaced around the border. During installation, as shown in FIG. 2, the fibrillation workpiece 2 is processed to provide a through hole 21 equal to the outer diameter of the T nut 1, and then the T nut 1 is plugged into the through hole 21, and then the T nut 1 is hammered to drive the upright retaining teeth 121 into the workpiece 2, and then tool means is threaded into the inner thread 114 of the tubular body 11 of the T nut 1 and operated to hammer down the plain end of the second section 112 of the tubular body 11 of the T nut 1 to form a head at one side of the fibrillation workpiece 2 against the flange 12 at the other side of the fibrillation workpiece 2. After installation of the T nut 1 in the workpiece 2, the tool means is removed from the T nut 1, and then a screw is threaded into the inner thread 114 of the tubular body 11 of the T nut 1. This design of T nut 1 is functional, however it has numerous drawbacks as outlined hereinafter.

1. Not Easy to Us:

Because the first section 111 and the second section 112 are formed integral with each other and the second section 112 has a intact peripheral wall, the tubular body 11 can bear a high stress in vertical direction. Simply threading a screw into the tubular body 11 does not cause the second section 112 to curve radially outwards for engaging into the peripheral wall of the through hole 21 of the workpiece 2, and tool means is necessary to hammer down the second section 112 of the tubular body 11 to form a head at one side of the workpiece 2 outside the through hole 21. Therefore, this installation procedure is complicated.

2. High Manufacturing Cost:

Because the height of the tubular body 11 must be greater than the thickness of the workpiece 2 so that the second section 112 of the tubular body 11 can be hammered down to form a head at one side of the workpiece 2, much material is necessary for the tubular body 11, resulting in a high manufacturing cost.

3. Bad Outer Looking:

When hammered down the second section 112 of the tubular body 11 to form a head at one side of the workpiece 2, the head will damage the surface of the workpiece 2 around the through hole 21. Therefore, the surface of the workpiece 2 is obstructed after installation of the T nut 1 in the workpiece 2.

Therefore, it is desirable to provide a T nut that eliminates the aforesaid drawbacks.

### SUMMARY OF THE INVENTION

The present invention has been accomplished under the circumstances in view. It is the main object of the present invention to provide a T nut, which is easy to install and inexpensive to manufacture. It is another object of the present invention to provide a T nut, which keeps the surface of the workpiece intact when installed.

To achieve these and other objects of the present invention, the T nut comprises a tubular body, said tubular body and a flange radially extended around the periphery of one end of the tubular body. The tubular body has a first section connected to the flange, and a second section axially extended from one end of the first section remote from the flange. The spaced surrounded by the first section is greater than the spaced surrounded by the second section. The first section has an inner thread on an inside wall thereof. The flange has a plurality of upright retaining teeth spaced around the border. The second section has a plurality of longitudinal splits, which separate the periphery of the second section into multiple curve surfaces. Further, the tubular body has a height shorter than the thickness of the fibrillation workpiece in which the T nut is to be installed.

### BRIEF DESCRIPTION OF THE DRAWINGS

FIG. 1 is a perspective view of a T nut according to the prior art.

FIG. 2 is a sectional view showing the prior art T nut fastened to the workpiece.

FIG. 3 is a perspective view of a T nut according to the present invention.

FIG. 4 is a sectional view of the present invention, showing the T nut fastened to the workpiece.

FIG. 5 is similar to FIG. 4 but showing the curve surfaces of the second section of the tubular body of the T nut engaged into the peripheral wall of the through hole of the workpiece.

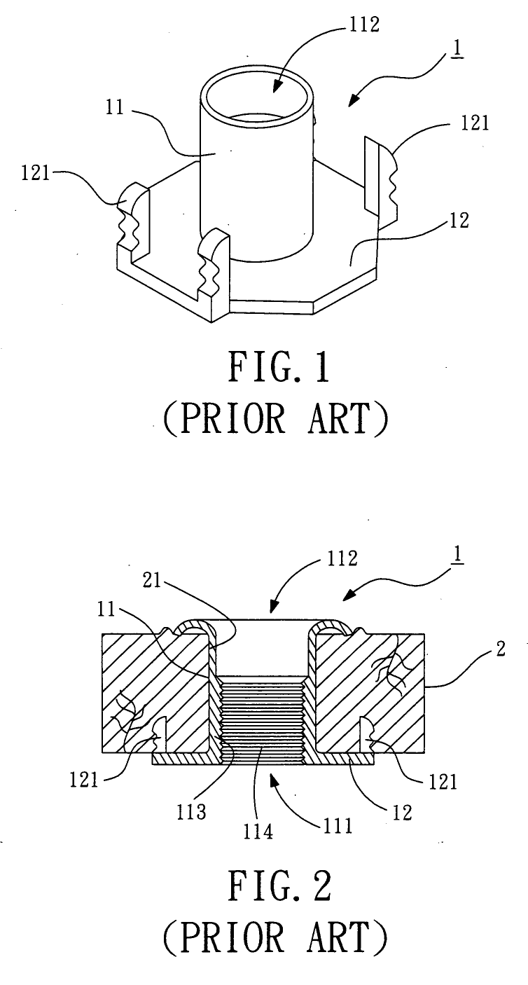

### DETAILED DESCRIPTION OF THE INVENTION

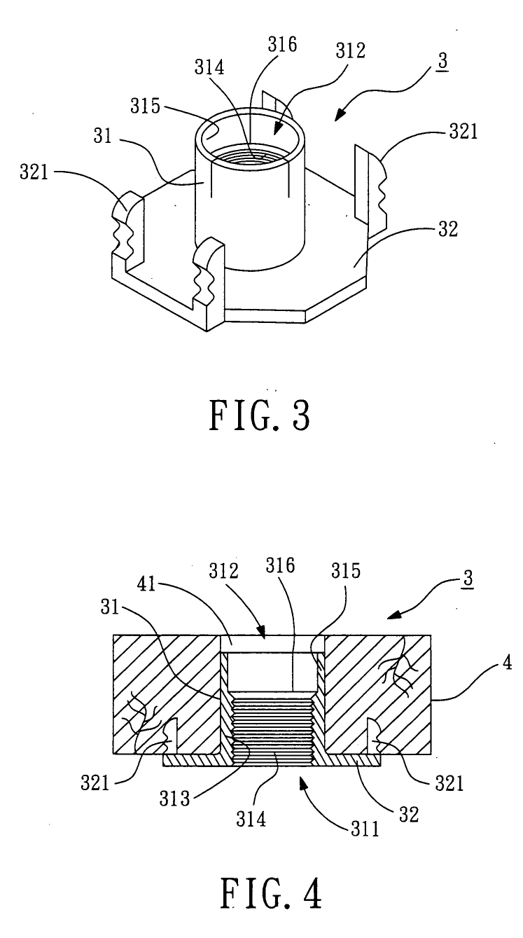

Referring to FIGS. 3 and 4, a T nut 3 in accordance with the present invention is shown comprising a tubular body 31 and a flange 32 radially extended around the periphery of the tubular body 31 at one end. The tubular body 31 has a first section 311 connected to the flange 32 and a second section 312 axially extended from one end of the first section 311 remote from the flange 32. The spaced surrounded by the first section 311 is greater than the spaced surrounded by the second section 312. The first section 311 has an inner thread 314 on the inside wall 313 thereof. The flange 32 has a plurality of upright retaining teeth 321 spaced around the border. The second section 312 has a plurality of longitudinal splits 316, which separate the periphery of the second section 312 into multiple curve surfaces.

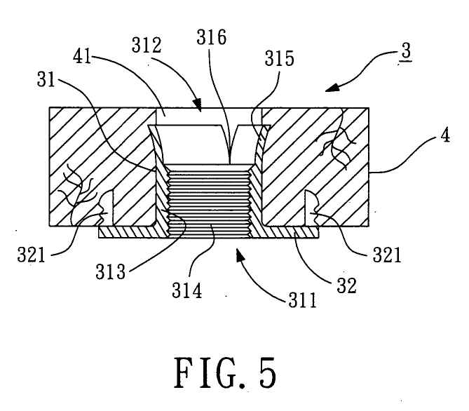

Referring to FIG. 5 and FIG. 4 again, the fibrillation workpiece, referenced by 4, is processed to provide a through hole 41 equal to the outer diameter of the T nut 3, and then the T nut 3 is plugged into the through hole 41, and then the T nut 3 is hammered to drive the upright retaining teeth 321 into the workpiece 4, and therefore the T nut 3 is affixed to the workpiece 4. Thereafter, a screw (not shown) is threaded into the inner thread 314 to stretch the tubular body 31 of the T nut 3 radially outwards against the peripheral wall of the through hole 41 of the workpiece 4. Because the second section 312 of the tubular body 31 of the T nut 3 has a plurality of longitudinal splits 316 that separate the periphery of the second section 312 into multiple curve surfaces, the vertical stress bearable to the tubular body 31 is relatively lowered. Therefore, the feed force of the screw causes the second section 312 to curve radially outwards. Further, because the height of the tubular body 31 is shorter than the thickness of the workpiece 4 and the workpiece 4 has a springy power, threading the screw into the radially outwardly curved curve surfaces of the second section 312 the inner thread 314 to stretch the tubular body 31 of the T nut 3 will cause the curve surfaces of the second section 312 to curve radially outwards and to engage into the peripheral wall of the through hole 41 of the workpiece 4 (see FIG. 5), keeping the flange 32 tightly secured to the bottom side of the workpiece 4.

Further, because the height of the tubular body 31 is shorter than the thickness of the workpiece 4, the tubular body 31 is kept inside the through hole 41 of the workpiece 4 and will not damage the surface of the workpiece 4 around the through hole 41. Therefore, the surface of the workpiece 4 is maintained intact after installation of the T nut 3 in the through hole 41 and the screw in the T nut 3.

As indicated above, the invention has the following advantages:

1. Ease of Use:

Because of the effect of the longitudinal splits in the second section of the tubular body, the periphery of the second section is separated into a plurality of curve surfaces that lower the vertical stress bearable to the tubular body. Therefore, threading the screw into the tubular body cause the curve surfaces of the second section to curve radially outwards and to engage into the peripheral wall of the through hole of the workpiece, keeping the T nut tightly secured to the workpiece. Therefore, the installation of the present invention is easy and simple without the use of tool means.

2. Low Manufacturing Cost.

Because the height of the tubular body of the T nut is shorter than the thickness of the workpiece, less material and manufacturing time are required for making the T nut. Relatively, the manufacturing cost of the T nut is lowered.

3. Nice Outer Looking after Installation.

Because the height of the tubular body of the T nut is shorter than the thickness of the workpiece, the tubular body of the T nut is kept inside the through hole of the workpiece and the surface of the workpiece around the through hole is maintained intact after installation of the T nut in the workpiece. Therefore, a nice outer looking is maintained after installation of the T nut in the workpiece and the screw in the T nut.

A prototype of T nut has been constructed with the features of FIGS. 3˜6. The T nut function smoothly to provide all of the features discussed earlier.

Although particular embodiments of the invention have been described in detail for purposes of illustration, various modifications and enhancements may be made without departing from the spirit and scope of the invention. Accordingly, the invention is not to be limited except as by the appended claims.

1. A T nut for fastening to a fibrillation plate member, comprising: a tubular body and a flange radially extended around the periphery of one end of said tubular body, said tubular body having a first section connected to said flange and a second section axially extended from one end of said first section remote from said flange, a space surrounding said first section being greater than a space surrounding said second section, said first section having an inner thread on an inside wall thereof, said flange having a plurality of upright retaining teeth spaced around a border thereof,
wherein said second section has a plurality of longitudinal splits parallel to a longitudinal axis of said tubular body defining a plurality of second segments, which separates a periphery of the second section into multiple curve surfaces without detachment from said tubular body, whereby when a screw is threaded into said first section of said T nut, said plurality of said second segments are radially displaced into coupling relationship with said fibrillation plate.

2. The T nut as claimed in claim 1, wherein said tubular body has a height shorter than a thickness of the fibrillation plate member in which the T nut is to be installed.
